(19) United States
(12) Patent Application Publication
(10) Pub. No.: US 2012/0106396 A1
(43) Pub. Date: May 3, 2012

(54) COMMUNICATION APPARATUS, COMMUNICATION APPARATUS CONTROL METHOD, AND PROGRAM

(75) Inventor: Tatsuhiko Sakai, Tokyo (JP)

(73) Assignee: CANON KABUSHIKI KAISHA, Tokyo (JP)

(21) Appl. No.: 13/380,974

(22) PCT Filed: Jul. 1, 2010
(86) PCT No.: PCT/JP2010/004326

§ 371 Date: Dec. 27, 2011

(30) Foreign Application Priority Data
Jul. 3, 2009 (JP) 2009-158943

(51) Int. Cl. H04W 84/18

(52) U.S. Cl. 370/254

(57) ABSTRACT

In an apparatus that can execute a plurality of communication parameter automatic setting methods, user-friendliness is improved. The communication apparatus selects whether to execute communication parameter setting processing with an access point or to execute communication parameter setting processing with another communication apparatus, which is different from the access point, based on a result of detecting apparatuses that is activating communication parameter setting processing.

### TECHNICAL FIELD

The present invention relates to a communication apparatus, a communication apparatus control method, and a program.

### BACKGROUND ART

In wireless communication represented by a wireless local access network (LAN) based on the Institute of Electrical and Electronics Engineers (IEEE) 802.11 standard series, there are many setting items to be set before use. Examples of such settings include a service set identifier (SSID) as a network identifier, an encryption system, an encryption key, an authentication method, an authentication key, and the like. It is very difficult for a user to manually input all of these settings.

Accordingly, various manufacturers have proposed automatic setting methods to enable easy setting of communication parameters in a wireless device. These automatic setting methods automatically set communication parameters between devices to be connected based on predetermined procedures and messages, by providing communication parameters from one of the devices to another device. Non-Patent Literature 1 discusses an example of automatic setting of communication parameters in wireless LAN infrastructure mode communication (infrastructure communication).

Patent Literatures 1 to 3 discuss examples of automatic setting of communication parameters in wireless LAN ad hoc mode communication (ad hoc communication). In Patent Literature 1 to 3, a device performing ad hoc communication determines a device (providing device) that provides communication parameters from among the devices joining the network, and the providing device provides the communication parameters to the other device (receiving device).

Thus, by utilizing automatic setting of communication parameters, the user can automatically set the communication parameters by a simple operation.

### CITATION LIST

### Patent Literature

PTL 1: Japanese Patent Application Laid-Open No. 2006-352282

PTL 2: Japanese Patent Application Laid-Open No. 2006-311138

PTL 3: Japanese Patent Application Laid-Open No. 2006-309458

### Non Patent Literature

NPL 1: Wi-Fi Certified (TM) for Wi-Fi Protected Setup: Easing the User Experience for Home and Small Office Wi-Fi (R) Networks,

http://www.wi-fi.org/wp/wifi-protected-setup

### SUMMARY OF INVENTION

### Technical Problem

A case will now be considered in which a plurality of communication parameter automatic setting methods is installed on a device. Conventionally, for a device in which a plurality of automatic setting functions are installed, the user selects the automatic setting method to be activated via a menu screen. However, in this case, the user himself/herself has to select the appropriate communication parameter automatic setting method, so that user-friendliness is poor. If the user selects the wrong automatic setting method, automatic setting processing is not executed, and wireless communication cannot be performed.

### Solution To Problem

The present invention is directed to a communication apparatus capable of executing a plurality of communication parameter automatic setting methods, and improving user-friendliness.

According to an aspect of the present invention, a communication apparatus, includes a first setting unit for executing a first setting process for setting communication parameter with an access point, a second setting unit for executing a second setting process for setting communication parameter with another communication apparatus which is not the access point, a detection unit configured to detect an apparatus activating the first or second setting processing, and a selection unit configured to select whether to perform the first setting process by the first setting unit or to perform the second setting process by the second setting unit, based on detection performed by the detection unit:

### Advantageous Effects of Invention

According to the present invention, even when a plurality of communication parameter automatic setting methods is installed on a device, the communication parameter automatic setting method can be automatically executed even without the user selecting the setting method. Consequently, user-friendliness improves.

Further features and aspects of the present invention will become apparent from the following detailed description of exemplary embodiments with reference to the attached drawings.

### BRIEF DESCRIPTION OF DRAWINGS

The accompanying drawings, which are incorporated in and constitute a part of the specification, illustrate exemplary embodiments, features, and aspects of the invention and, together with the description, serve to explain the principles of the invention.

FIG. 1 is a block configuration diagram of an apparatus according to an exemplary embodiment of the present invention.

FIG. 2 is a software function diagram of an apparatus according to an exemplary embodiment of the present invention.

FIG. 3 is a network configuration diagram according to an exemplary embodiment of the present invention.

FIG. 4 is an operation flowchart of communication processing of an apparatus A according to an exemplary embodiment of the present invention.

FIG. 5 is an operation sequence diagram of an apparatus A, an apparatus B, and an access point according to an exemplary embodiment of the present invention.

FIG. 6 is an operation sequence diagram of an apparatus A, an apparatus B, and an access point according to an exemplary embodiment of the present invention.

FIG. 7 is an operation sequence diagram of an apparatus A, an apparatus B, and an access point according to an exemplary embodiment of the present invention.

### DESCRIPTION OF EMBODIMENTS

Various exemplary embodiments, features, and aspects of the invention will be described in detail below with reference to the drawings.

### EXAMPLE 1

A communication apparatus according to the present exemplary embodiment will now be described in more detail with reference to the drawings. Although the following example is described using a LAN system based on the IEEE 802.11 series, the communication mode is not limited to a wireless LAN based on IEEE 802.11.

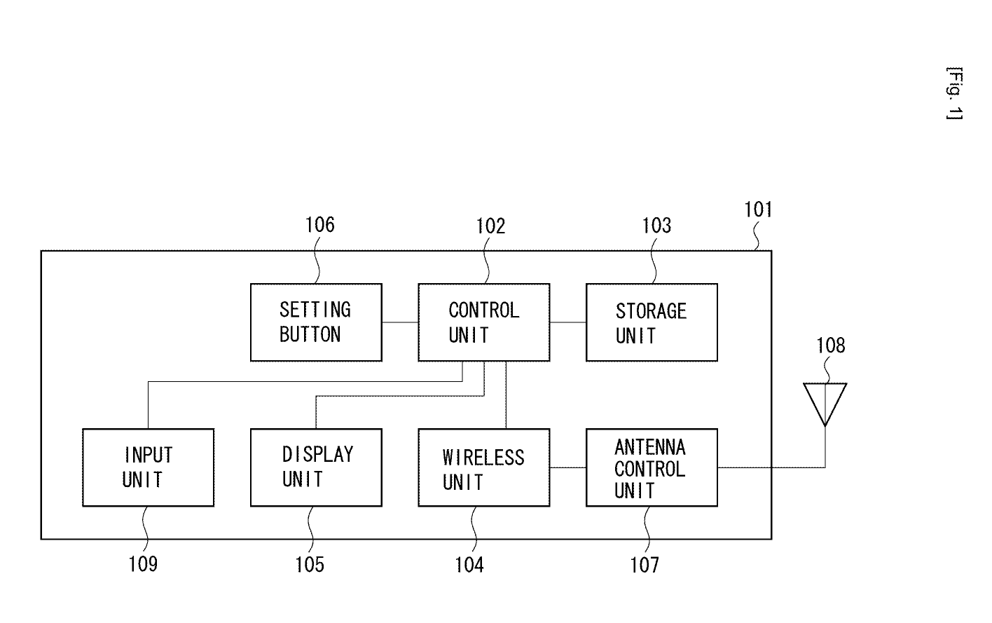

The hardware configuration according to the present exemplary embodiment will now be described. FIG. 1 is a block diagram illustrating an example of the configuration of respective apparatuses to be described below. An apparatus 101 includes a control unit 102 that controls the overall apparatus by executing a control program stored in a storage unit 103. The control unit 102 is a computer such as a central processing unit (CPU), a microprocessor unit (MPU), and the like. The control unit 102 performs automatic setting control of communication parameters with another apparatus. Examples of communication parameter automatic setting control include automatic setting processing of a wireless LAN infrastructure mode and automatic setting processing of a wireless LAN ad hoc net mode.

The storage unit 103 stores various information, such as a computer program for control that is executed by the control unit 102, and communication parameters. Various below-described operations are performed by the control unit 102 executing the control program stored in the storage unit 103. As the storage unit 103, a memory such as a read-only memory (ROM) and a random access memory (RAM) may be used, or a flexible disk, a hard disk, an optical disc, a compact disc (CD) ROM, a CD-recordable (CD-R), a magnetic tape, a non-volatile memory card, a digital versatile disc (DVD), and the like may be used.

A wireless unit 104 performs wireless communication. A display unit 105 performs various displays. The display unit 105 has a function for outputting visually recognizable information, such as by a liquid crystal display (LCD) or a light-emitting diode (LED), or a function enabling audio output such as by a speaker. A setting button 106 serves as a trigger for activating communication parameter setting processing. When the control unit 102 detects an operation from the setting button 106 by the user, the control unit 102 executes the below-described processing. The configuration illustrated in FIG. 1 also includes an antenna control unit 107, an antenna 108, and an input unit 109, which allows the user to perform various inputs.

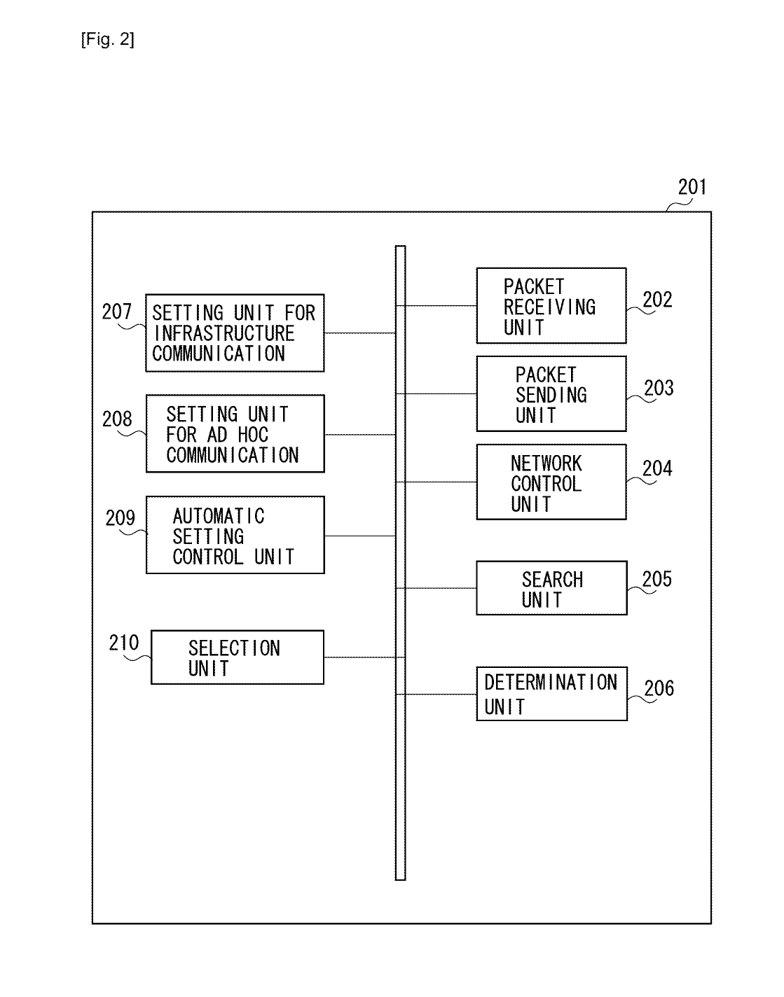

FIG. 2 is a configuration example of software function blocks executed by an apparatus in a below-described communication parameter automatic setting operation. In FIG. 2, an apparatus 201 includes a packet receiving unit 202 that receives packets relating to various kinds of communication. Reception of a beacon (notification signal) is performed by the packet receiving unit 202. In addition, a device search signal such as a probe request is also received by the packet receiving unit 202. A probe request can also be called a network search signal for searching for a desired network. Further, reception of a probe response, which is a signal in response to a probe request, is also performed by the packet receiving unit 202.

A packet sending unit 203 sends packets relating to various kinds of communication. Sending of a beacon is performed by the packet sending unit 203. In addition, the packet sending unit 203 also performs sending of a probe request and sending of a probe response, which is a signal in response to a probe request. Various information about the sending device (self-information) is added to the device search signal and to the response signal thereof. This self-information also includes information indicating whether communication parameter automatic setting processing is activating. A network control unit 204 controls network connection. Connection processing to the wireless LAN network is executed by the network control unit 204.

A search unit 205 searches for nearby devices by sending a probe request using the packet sending unit 203, and receiving a probe response using the packet receiving unit 202. The search unit 205 also searches for nearby networks by receiving a beacon signal using the packet receiving unit 202.

Based on a search result of the search unit 205, a determination unit 206 determines whether an access point activating automatic setting processing is present based on a detection result obtained by performing detection processing of access points activating communication parameter automatic setting processing for infrastructure communication.

Examples of the communication parameter automatic setting processing for infrastructure communication include industry-standard processing, such as Wi-Fi Protected Setup, and proprietary processing provided by individual manufacturers. Further, the determination unit 206 also determines whether a device activating communication parameter automatic setting processing for ad hoc mode communication is present.

An infrastructure communication setting unit 207 receives communication parameters for infrastructure communication from an access point serving as a station. This function block executes a predetermined first setting processing protocol with an access point, and receives from the access point the communication parameters required for performing wireless communication, such as the SSID as a network identifier, the encryption system, the encryption key, the authentication method, the authentication key, and the like.

An ad hoc communication setting unit 208 provides or receives communication parameters for ad hoc communication to or from another apparatus. This function block executes a predetermined second setting processing protocol based on ad hoc communication with the other apparatus, and performs the communication parameter automatic setting processing required for performing wireless communication, such as the SSID as a network identifier, the encryption system, the encryption key, the authentication method, the authentication key and the like.

An automatic setting control unit 209 controls to activate of an automatic setting method. This function block selectively activates either the setting process of the infrastructure network by the infrastructure communication setting unit 207 or the setting process of the ad hoc network by the ad hoc communication setting unit 208 in order to perform automatic setting processing for the method selected by a selection unit 210. Further, the automatic setting control unit 209 performs detection processing of setting button 106 operations by monitoring whether the setting button 106 is operated by the user.

The selection unit 210 selects whether to execute communication parameter automatic setting processing for infrastructure communication or to execute communication parameter automatic setting processing for ad hoc communication based on a determination result by the determination unit 206.

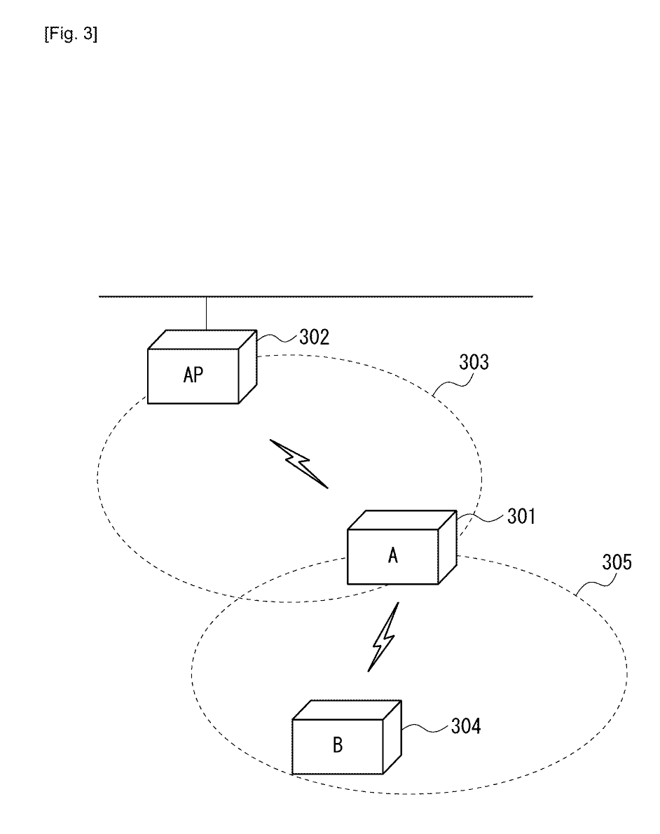

FIG. 3 illustrates a communication apparatus A 301 (apparatus A), an access point 302, and a communication apparatus B 304 (apparatus B). Apparatus A has the configuration as illustrated in FIGS. 1 and 2. The access point 302 provides communication parameters to the apparatus A by executing communication parameter automatic setting processing for infrastructure communication based on an instruction from the user, and communicating over a network 303.

In infrastructure communication, the apparatus A is operated as a station (slave station) of the access point 302, and performs communication via the access point 302. Further, in ad hoc communication, the apparatus A performs direct communication with another apparatus (apparatus B) without going via the access point 302. The access point 302 may also be referred to as a base station, a key station, a control apparatus (station) and the like. The access point 302 creates (constructs) the infrastructure network, and performs control to allow the station apparatus (slave station) to communicate.

Further, the apparatus B shares the communication parameters with the apparatus A by executing communication parameter automatic setting processing for ad hoc communication, and performing communication over a network 305. The communication parameters may be provided from the apparatus A to the apparatus B, or from the apparatus B to the apparatus A. In the present exemplary embodiment, infrastructure communication and ad hoc communication are performed by a method based on the IEEE 802.11 series.

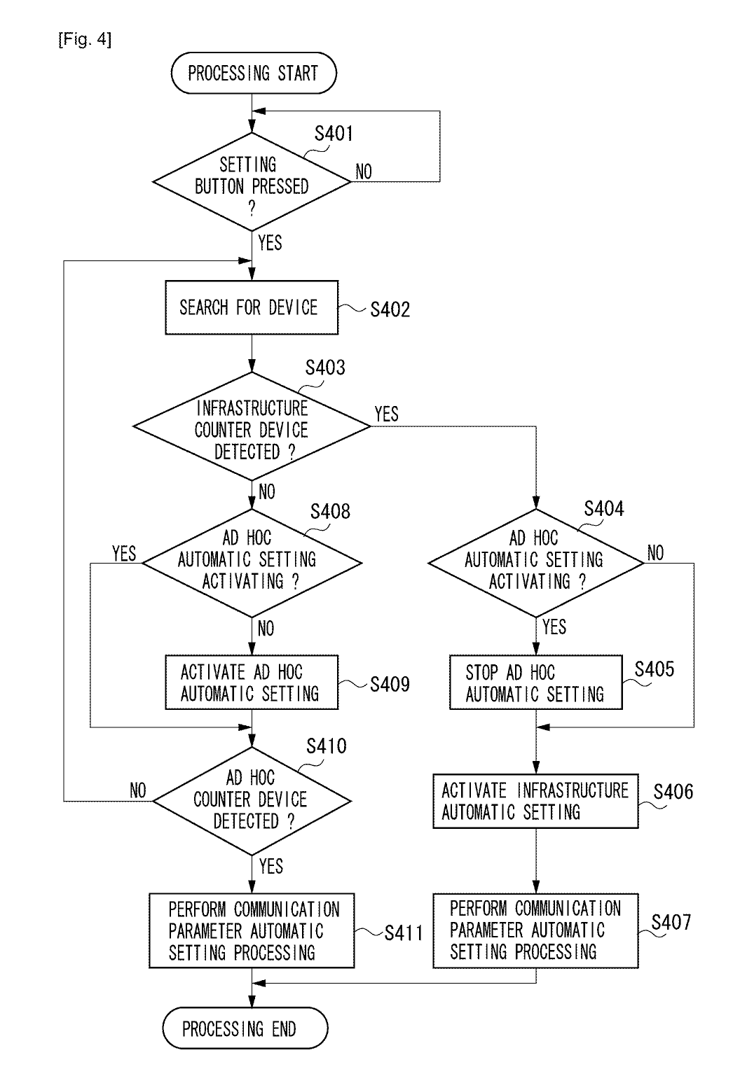

FIG. 4 is an operation flowchart of communication processing executed when the setting button 106 is pressed by the user in the apparatus A. The processing performed in FIG. 4 is performed by the control unit 102 reading a computer program stored in the storage unit 103 and executing the read computer program.

In step S401, the control unit 102 (automatic setting control unit 209) monitors whether the setting button 106 has been pressed. If the control unit 102 detects that the setting button 106 has been pressed by the user (YES in step S401), the control unit 102 activates the search unit 205. In step S402, the search unit 205 searches for nearby devices by sending a probe request using the packet sending unit 203, and receiving a probe response using the packet receiving unit 202.

Further, the search unit 205 may also search for nearby networks by receiving a beacon signal using the packet receiving unit 202. In step S403, the determination unit 206 determines whether an access point activating communication parameter automatic setting processing for infrastructure communication is present by confirming the self-information included in the received beacon or probe response.

If an access point activating communication parameter automatic setting processing for infrastructure communication is present (YES in step S403), the selection unit 210 determines that communication parameter automatic setting processing for infrastructure communication is to be executed. Then, in step S404, if the selection unit 210 selects execution of automatic setting processing for infrastructure communication, the automatic setting control unit 209 confirms whether the ad hoc communication setting unit 208 is activating.

If the ad hoc communication setting unit 208 is activating (YES in step S404), in step S405, the automatic setting control unit 209 stops operation of the ad hoc communication setting unit 208. Then, in step S406, the automatic setting control unit 209 activates the setting process by the infrastructure communication setting unit 207. In step S407, the infrastructure communication setting unit 207 executes communication parameter automatic setting processing with the access point 302.

Further, in step S404, if the ad hoc communication setting unit 208 is not activating (NO in step S404), the processing proceeds to step S406. In step S406, the automatic setting control unit 209 activates the setting process by the infrastructure communication setting unit 207. Then, in step S407, the infrastructure communication setting unit 207 executes communication parameter automatic setting processing with the access point 302. As a result of the infrastructure communication setting unit 207 executing automatic setting processing with the access point 302, the apparatus A acquires the communication parameters from the access point 302.

When the apparatus A acquires the communication parameters from the access point 302, based on a control by the network control unit 204, the apparatus A utilizes the acquired communication parameters to connect to the access point 302. Then, the apparatus A joins the infrastructure network formed by the access point 302, and performs communication.

Based on the confirmation result of step S403, if it is determined that an access point activating communication parameter automatic setting processing for infrastructure communication is not present (NO in step S403), the selection unit 210 determines that communication parameter automatic setting processing for ad hoc communication is to be executed.

If the selection unit 210 determines that automatic setting processing for ad hoc communication is to be executed (NO in step S403), in step S408, the automatic setting control unit 209 confirms whether the ad hoc communication setting unit 208 is activating. If the ad hoc communication setting unit 208 is not activating (NO in step S408), in step S409, the automatic setting control unit 209 activates the ad hoc communication setting unit 208.

In step S410, the automatic setting control unit 209 confirms whether a device activating communication parameter automatic setting processing for ad hoc communication is present by confirming the search result acquired by the search performed in step S402. If a device (apparatus B) activating communication parameter automatic setting processing for ad hoc communication is present (YES in step S410), in step S411, the ad hoc communication setting unit 208 executes communication parameter automatic setting processing with the apparatus B, and shares the communication parameters.

When the apparatus A shares the communication parameters with the apparatus B, based on a control from the network control unit 204, the apparatus A utilizes the acquired communication parameters to form an ad hoc network with the apparatus B. Then, communication is performed between the apparatus A and the apparatus B.

Based on the determination result of step S410, if it is determined that a device activating communication parameter automatic setting processing for ad hoc communication is not present (NO in step S410), the processing returns to step S402 with the ad hoc communication setting unit 208 still activating, and the search unit 205 again tries to search for devices.

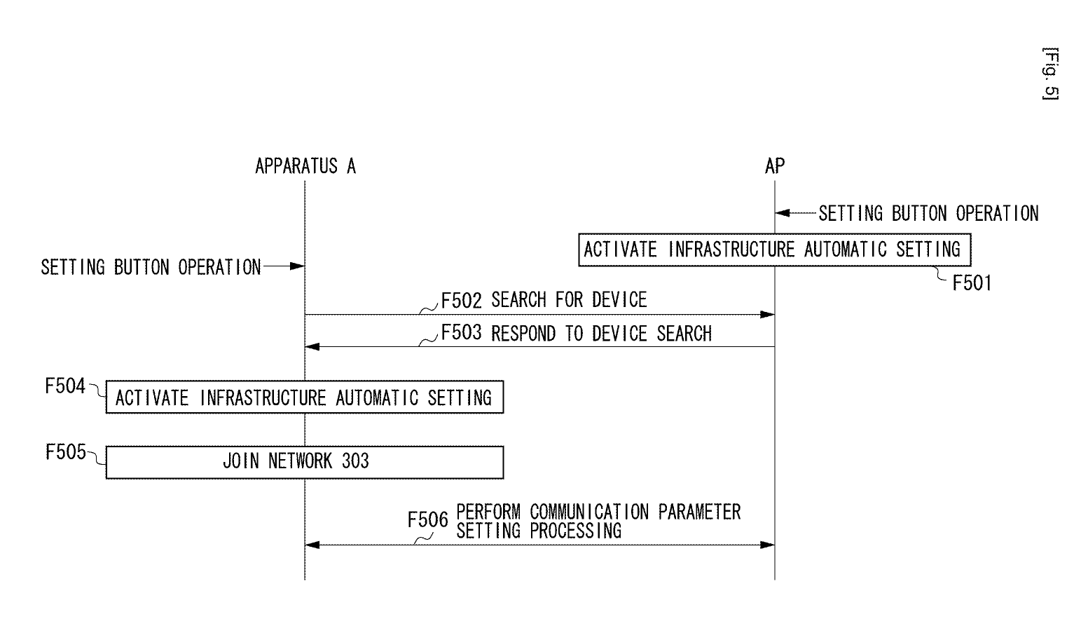

FIG. 5 illustrates a processing sequence when the setting button of the access point 302 is pressed, automatic setting processing is activated, then the setting button 106 on the apparatus A is pressed, and communication parameter automatic setting processing is executed between the apparatus A and the access point 302.

When the setting button of the access point 302 is pressed, in F501, the access point 302 activates communication parameter automatic setting processing for infrastructure communication. After activating this, the access point 302 adds information indicating that the access point 302 is activating automatic setting processing to the beacon or probe response, and sends that beacon or probe response.

When the setting button 106 of the apparatus A is pressed, the apparatus A activates the processing illustrated in FIG. 4. In F502, the apparatus A sends a device search signal (probe request) for searching for a network, and confirms whether there are any nearby devices activating automatic setting processing. In F503, the access point 302 sends to the apparatus A a response signal (probe response) including self-information indicating that the access point 302 is activating automatic setting processing.

When the apparatus A receives a probe response from the access point 302, the apparatus A confirms that communication parameter automatic setting processing for infrastructure communication is activating. If the apparatus A discovers an access point that is activating communication parameter automatic setting processing for infrastructure communication, in F504, the apparatus A activates communication parameter automatic setting processing for infrastructure communication.

Then, in F505, the apparatus A joins the network 303 of the access point 302. In F506, the apparatus A executes automatic setting processing for infrastructure communication with the access point 302. Consequently, the apparatus A acquires the communication parameters from the access point 302.

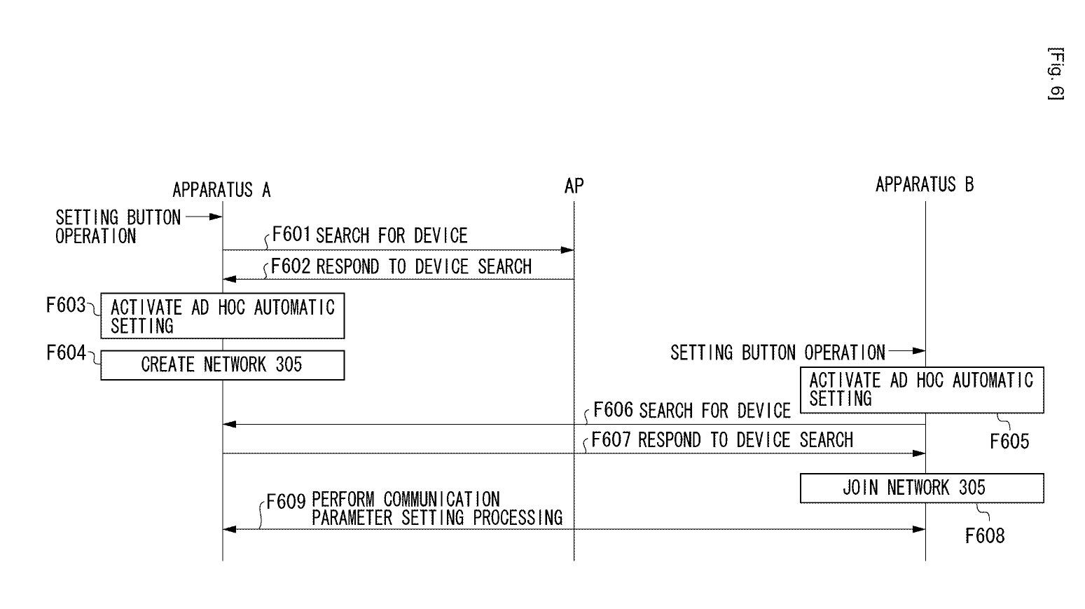

FIG. 6 illustrates a processing sequence when the setting button 106 is pressed on the apparatus A, then the setting button is pressed on the apparatus B, and communication parameter automatic setting processing is executed between the apparatus A and the apparatus B.

When the setting button 106 of the apparatus A is pressed, the apparatus A activates the processing illustrated in FIG. 4. In F601, the apparatus A sends a probe request for searching for a network, and confirms whether there are any nearby devices activating automatic setting processing. In F602, the access point 302 sends a probe response indicating that the access point 302 is not activating automatic setting processing to the apparatus A. Consequently, in F603, the apparatus A activates communication parameter automatic setting processing for ad hoc communication. After activating this process, in F604, the apparatus A creates (constructs) the network 305.

Subsequently, after the setting button of the apparatus B is pressed, in F605, the apparatus B activates communication parameter automatic setting processing for ad hoc communication. Further, similar to the apparatus A, the apparatus B may also perform the communication parameter automatic setting processing for ad hoc communication by executing the processing of FIG. 4. If the communication parameter automatic setting processing for ad hoc communication is activated, in F606, the apparatus confirms whether there are any nearby devices activating communication parameter automatic setting processing for ad hoc communication.

When the apparatus A receives the probe request sent from the apparatus B, in F607, the apparatus A sends to the apparatus B a probe response including self-information indicating that the apparatus A is activating automatic setting processing. When the apparatus B receives the probe response sent from the apparatus A, in F608, the apparatus B joins the network 305 created by the apparatus A. Then, in F609, communication parameter automatic setting processing is performed between the apparatus A and the apparatus B. In the automatic setting processing between the apparatus A and the apparatus B, the communication parameters may be provided from the apparatus A to the apparatus B, or from the apparatus B to the apparatus A.

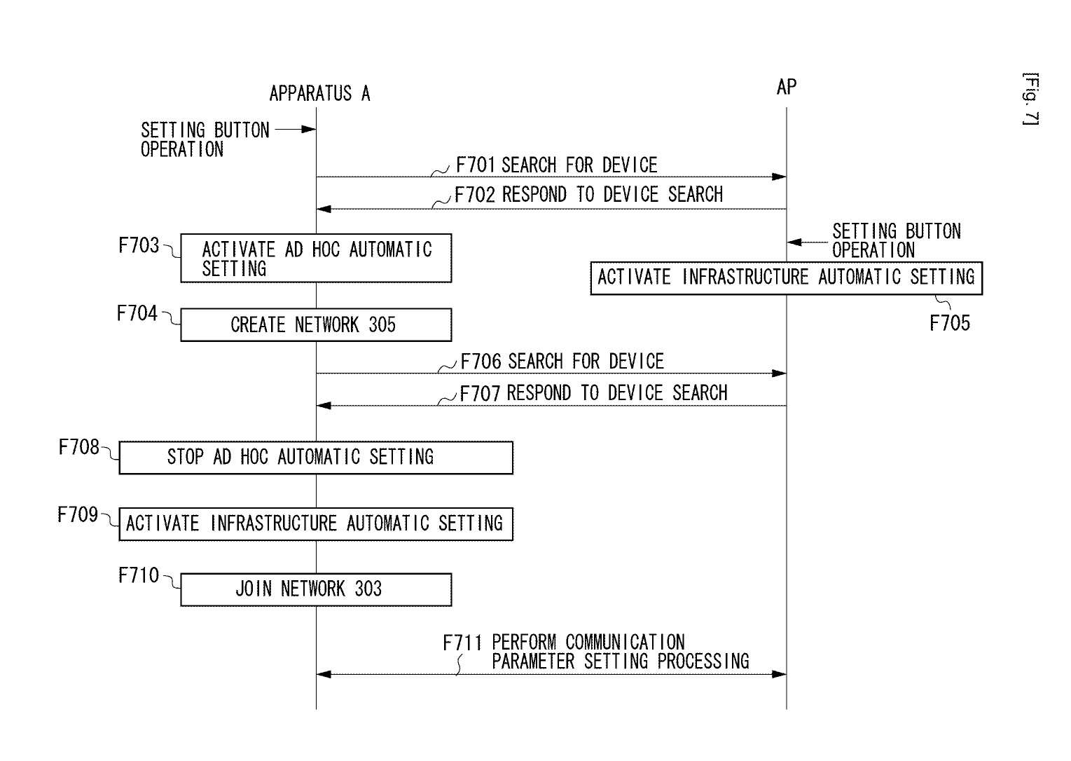

FIG. 7 illustrates a processing sequence when the setting button 106 is pressed on the apparatus A, then the setting button is pressed on the access point 302, and communication parameter automatic setting processing is executed between the apparatus A and the access point 302.

When the setting button 106 of the apparatus A is pressed, the apparatus A activates the processing illustrated in FIG. 4. In F701, the apparatus A sends a probe request, and confirms whether there are any nearby devices activating automatic setting processing. In this example, since the access point 302 is not activating automatic setting processing, in F702, the access point 302 sends a probe response indicating that the access point 302 is not activating automatic setting processing to the apparatus A. Consequently, in F703, the apparatus A activates communication parameter automatic setting processing for ad hoc communication. After activating this process, in F704, the apparatus A creates the network 305, and then continues the device search processing illustrated in FIG. 4.

Subsequently, when the setting button of the access point 302 is pressed, in F705, the access point 302 activates communication parameter automatic setting processing for infrastructure communication. After activating this process, the access point 302 adds information indicating that the access point 302 is activating automatic setting processing to the beacon or probe response, and sends that beacon or probe response.

Since the apparatus A has not found a counterparty, which is activating automatic setting processing, in F706, the apparatus A resends a probe request to confirm whether there are any nearby devices activating automatic setting processing. The access point 302 receives this probe request. Then, in F707, the access point 302 returns a probe response to which information indicating that the access point 302 is activating automatic setting processing is added.

Further, in F707, the apparatus A receives from the access point 302 the probe response including the self-information indicating that the access point 302 is activating automatic setting processing. When receiving this probe response, the apparatus A recognizes the fact that the access point 302 is activating communication parameter automatic setting processing for infrastructure communication. Consequently, in F708, the apparatus A stops the communication parameter automatic setting processing for ad hoc communication that had been activating. Then, in F709, the apparatus A activates communication parameter automatic setting processing for infrastructure communication.

When the communication parameter automatic setting processing for infrastructure communication activates, in F710, the apparatus A joins the network 303 of the access point 302. Then, in F711, the apparatus A executes automatic setting processing with the access point 302, and acquires the communication parameters from the access point 302.

Thus, the apparatus A executes appropriate communication parameter automatic setting processing by automatically detecting nearby devices that are activating automatic setting processing. Further, when the device search of step S402 in FIG. 4 is executed, in some cases a plurality of devices activating automatic setting processing may be detected.

In such a case, the automatic setting control unit 209 may execute communication parameter automatic setting processing with an unintended apparatus. To prevent acquisition or provision of communication parameters from an unintended counterparty, the processing is ended as an error. For example, in step S402 of FIG. 4, if the presence of an access point activating communication parameter automatic setting processing for infrastructure communication is recognized, as performed in step S410, the automatic setting control unit 209 confirms whether a device activating communication parameter automatic setting processing for ad hoc communication is present.

When a device activating communication parameter automatic setting processing for ad hoc communication is recognized, and both communication parameter automatic setting processing for infrastructure communication and communication parameter automatic setting processing for ad hoc communication are activating is recognized, the processing is ended as an error.

Further, when a plurality of access points activating communication parameter automatic setting processing for infrastructure communication are recognized, and a plurality of devices activating communication parameter automatic setting processing for ad hoc communication are recognized, the processing is ended. Thus, when there are a plurality of counterparties activating communication parameter automatic setting processing, automatic setting processing is not performed. This is to prevent acquisition or provision of communication parameters from or to an unintended counterparty due to communication parameter automatic setting processing being executed with an unintended counterparty.

Thus, even when a plurality of communication parameter automatic setting processing methods are installed in the apparatus, the communication parameter automatic setting processing method can be automatically selected and executed even if the user does not select the method, thereby increasing user-friendliness. In the present exemplary embodiment described above, automatic setting processing is selected based on whether the access point is activating automatic setting processing for infrastructure communication or some other apparatus (station) is activating automatic setting processing for ad hoc communication. Further, since the selected processing is executed, automatic setting processing suitable for the environment can be executed, thereby increasing user-friendliness.

The exemplary embodiment of the present invention has been described above. However, this exemplary embodiment is for the purpose of illustrating the present invention, and is in no way meant to limit the scope of the present invention. The above-described exemplary embodiment may be variously modified within the scope of the present invention. Further, the exemplary embodiment has been described using a wireless LAN based on IEEE 802.11 as an example. However, the present invention may also be employed in some other wireless medium, such as wireless universal serial bus (USB), MBOA, Bluetooth(registered trademark), ultra-wideband (UWB), ZigBee and the like. In addition, the present invention can also be employed in a wired communication medium, such as a wired LAN.

Here, MBOA is an abbreviation for multi band OFDM alliance. UWB includes wireless USB, wireless 1394, wireless network (WINET), and the like.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-158943 filed Jul. 3, 2009, which is hereby incorporated by reference herein in its entirety.

1. A communication apparatus, comprising:
a first setting unit for executing a first setting process for setting communication parameters with an access point;
a second setting unit for executing a second setting process for setting communication parameters with another communication apparatus that is not the access point;
a detection unit configured to detect an apparatus that is activating the first or second setting process; and
a selection unit configured to select whether to perform the first setting process by the first setting unit or to perform the second setting process by the second setting unit, based on detection performed by the detection unit.

2. The communication apparatus according to claim 1, wherein if an access point that is activating the first setting process is detected by the detection unit, the selection unit selects executing the first setting process by the first setting unit.

3. The communication apparatus according to claim 1, wherein if an access point activating the first setting process is detected by the detection unit and another communication apparatus that is activating the second setting process is not detected, the selection unit selects executing the first setting process by the first setting unit.

4. The communication apparatus according to claim 1, wherein if an access point that is activating the first setting process is not detected by the detection unit, the selection unit selects executing the second setting process by the second setting unit.

5. The communication apparatus according to claims 1, wherein if another communication apparatus that is activating the second setting process is detected by the detection unit and an access point that is activating the first setting process is not detected by the detection unit, the selection unit selects executing the second setting process by the second setting unit.

6. The communication apparatus according to claim 1, wherein if the selection unit selects and activates the second setting processing by the second setting unit, and neither an access point that is activating the first setting process nor another communication apparatus that is activating the second setting process is detected by the detection unit, the detection unit detects an apparatus that is activating communication parameter setting processing in a state in which the second setting process by the second setting unit is activating.

7. The communication apparatus according to claim 6, wherein after the second setting process by the second setting unit is activated, if an access point that is activating the first setting processing is detected by the detection unit, the communication apparatus stops the second setting process.

8. A communication apparatus, comprising:
a first setting unit for executing communication parameter setting processing with an access point;
a second setting unit for executing communication parameter setting processing with another communication apparatus that is different from the access point;
a detection unit configured to detect an access point that is activating first communication parameter setting processing or another apparatus that is activating second communication parameter setting processing; and
an execution unit configured to selectively execute setting processing by the first setting unit and setting processing by the second setting unit, based on detection performed by the detection unit.

9. A communication apparatus, comprising:
a first setting unit for executing communication parameter setting processing in an infrastructure mode;
a second setting unit for executing communication parameter setting processing in an ad hoc mode;
a detection unit configured to detect an apparatus that is activating communication parameter setting processing; and
a selection unit configured to select whether to perform setting processing by the first setting unit or to perform setting processing by the second setting unit, based on the detection performed by the detection unit.

10. A method for controlling a communication apparatus, comprising:
detecting an apparatus that is activating communication parameter setting processing; and
selecting whether to execute communication parameter setting processing with an access point based on a first setting processing or to execute communication parameter setting processing with another communication apparatus, which is different from the access point, based on second setting processing, according to a detection result.

11. A method for controlling a communication apparatus, comprising:
detecting an access point that is activating first communication parameter setting processing or another communication apparatus that is activating second communication parameter setting processing; and
selectively executing the first communication parameter setting processing with the access point and the second communication parameter setting processing with another communication apparatus, which is different from the access point, based on the detection result.

12. A method for controlling a communication apparatus, comprising:
detecting an apparatus that is activating communication parameter setting processing; and
selectively executing communication parameter setting processing in an infrastructure mode and communication parameter setting processing in an ad hoc mode, based on the detection result.

13. A computer readable storage medium storing a computer-executable program of instruction for causing a computer to function as the communication apparatus according to claim 1.

14. The computer readable storage medium according to claim 13, wherein in the communication apparatus, if an access point that is activating the first setting process is detected by the detection unit, the selection unit selects executing the first setting process by the first setting unit.

15. The computer readable storage medium according to claim 13, wherein in the communication apparatus, if an access point activating the first setting process is detected by the detection unit and another communication apparatus that is activating the second setting process is not detected, the selection unit selects executing the first setting process by the first setting unit.

16. The computer readable storage medium according to claim 13, wherein in the communication apparatus, if an access point that is activating the first setting process is not detected by the detection unit, the selection unit selects executing the second setting process by the second setting unit.

17. The computer readable storage medium according to claim 13, wherein in the communication apparatus, if another communication apparatus that is activating the second setting process is detected by the detection unit and an access point that is activating the first setting process is not detected by the detection unit, the selection unit selects executing the second setting process by the second setting unit.

18. The computer readable storage medium according to claim 13, wherein in the communication apparatus, if the selection unit selects and activates the second setting processing by the second setting unit, and neither an access point that is activating the first setting process nor another communication apparatus that is activating the second setting process is detected by the detection unit, the detection unit detects an apparatus that is activating communication parameter setting processing in a state in which the second setting process by the second setting unit is activating.

19. The computer readable storage medium according to claim 13, wherein in the communication apparatus, after the second setting process by the second setting unit is activated, if an access point that is activating the first setting processing is detected by the detection unit, the communication apparatus stops the second setting process.
